(19) United States
(12) Patent Application Publication
(10) Pub. No.: US 2010/0214113 A1
(43) Pub. Date: Aug. 26, 2010

(54) Active Light-Emitting Alert Device

(76) Inventor: Hsi-Chi Chang, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/393,932

(22) Filed: Feb. 26, 2009

(51) Int. Cl. G08B 5/22

(52) U.S. Cl. 340/815.45

(57) ABSTRACT

Provided is an active light-emitting alert device including a first light alarm, a second light alarm, a control unit, a power supply, and at least one connection component. Both first and second light alarms have at least one surface provided with a light-emitting alert block including a plurality of light-emitting components arranged in a matrix. The control unit and the power supply enable the light-emitting alert blocks to emit textual or glittering alert light or alert light for indicating a direction. Two ends of each of the connection components are coupled to a selected portion of the first and second light alarms. With the connection component, the active light-emitting alert device is carried by a user or placed at a specific venue to emit alert light and indication light actively, alerting other drivers or persons to imminent danger, and ensuring the user's safety.

### BACKGROUND OF THE INVENTION

1. Field of the Invention

The present invention relates to an active light-emitting alert device, and more particularly, to a light-emitting alert device carried by a user or placed at a specific venue to emit alert light and indication light actively.

2. Description of the Prior Art

Human beings' lifestyle inevitably involves undertaking risky activities, such as riding a bicycle side by side with a vehicle or motorbike, jogging at night, nightwalking. Also, some specialty occupations are carried out in hazardous workplaces, such as traffic police, traffic auxiliary police, road maintenance workers, or street cleaners. During the aforesaid dangerous activities performed in daily life or by occupation, an alert device carried by a user or installed on a related equipment is useful for alerting other vehicle drivers or motorbike riders to the user's presence, and asking them to stop, evade or take a related action as needed. For example, in general, rearward red reflectors installed on bicycles and roadside emergency reflective triangle kits rely upon headlights of vehicles and motorbikes in order to bring about reflection for drawing attention from other drivers. In addition, reflective strips are sewn on sportswear, such as sports shirts, shorts, or sneakers, for use in jogging or cycling. Furthermore, traffic police officers, traffic auxiliary police officers, road maintenance workers, and street cleaners have to wear a reflective-strip-laden vest on their uniform while on duty on a road or at workplace, so as to give an alert by reflection.

However, conventional bicycle rearward reflectors, conventional roadside emergency reflective triangle kits, and conventional reflective strips sewn on working uniforms and working vests are passive alert devices, as they produce reflection only when irradiated by a light source. Their alerting function deteriorates as a result of insufficient light sources, deviated projection of light, or dim incident light rays. Deteriorated alerting function of the passive alert devices increases the likelihood of the hazardous outcome. Road maintenance workers and street cleaners working at midnight and any person riding a bicycle at night expose themselves to life-threatening danger in the absence of enhanced, conspicuous alert light, as drivers are more likely to be inattentive and driving fast at night.

Accordingly, the present invention is to address an urgent issue, namely developing an active light-emitting alert device that provides a safe daily life environment and safe workplace for the aforesaid recreational exercise-takers, bicycle riders, traffic police officers, traffic auxiliary police officers, road maintenance workers, and street cleaners.

### SUMMARY OF THE INVENTION

In view of the shortcomings of the conventional passive alert devices, the inventor of the present invention believes that there is room for improvement in the conventional passive alert devices and finally succeeded in developing an active light-emitting alert device based on the inventor's years of practical experience of the related field with a view to effectuating the alert function efficiently and markedly.

It is a primary objective of the present invention to provide an active light-emitting alert device comprising a first light alarm, a second light alarm, a control unit, a power supply, and connection components, such that the active light-emitting alert device is carried by a user or placed at a specific venue to emit enhanced, conspicuous glittering light for giving indication and an alert.

To achieve the above and other objectives, the present invention provides an active light-emitting alert device, comprising: a first light alarm with at least one surface provided with a light-emitting alert block, the light-emitting alert block comprising a plurality of light-emitting components arranged in a matrix; a second light alarm with at least one surface provided with a light-emitting alert block, the light-emitting alert block comprising a plurality of light-emitting components arranged in a matrix; a control unit electrically connected to the light-emitting alert block of the first light alarm and the light-emitting alert block of the second light alarm; a power supply electrically connected to the control unit, the light-emitting alert block of the first light alarm, and the light-emitting alert block of the second light alarm; and at least one connection component with two ends coupled to a selected portion of the first light alarm and the second light alarm, respectively.

### BRIEF DESCRIPTION OF THE DRAWINGS

FIG. 1 is a perspective view of a preferred embodiment of the present invention;

FIG. 2 is a schematic view of application of the present invention for cycling;

FIG. 3 is a schematic view of application of the present invention for jogging or working;

FIG. 4 is a schematic view of application of the present invention when alerting people of vehicle failure; and

FIG. 5 is a perspective view of another preferred embodiment of the present invention.

### DETAILED DESCRIPTION OF THE EMBODIMENTS

The present invention is herein illustrated with preferred embodiments in conjunction with the accompanying drawings, so that one skilled in the pertinent art can easily understand other objectives, features, advantages and effects of the present invention from the detailed description of the invention.

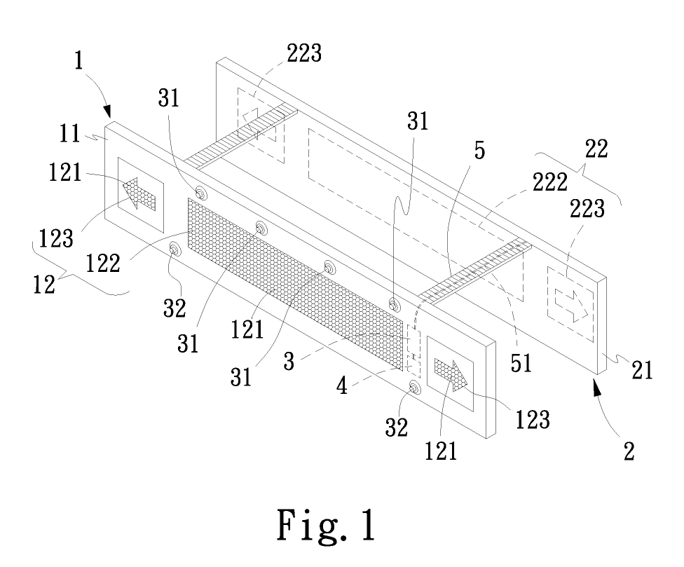

Referring to FIG. 1, in a preferred embodiment of the present invention, an active light-emitting alert device comprises a first light alarm 1, a second light alarm 2, one or more control units 3, one or more power supplies 4, and one or more connection components 5.

Referring to FIG. 1 again, the first light alarm 1 comprises a substrate 11, and the substrate 11 has at least one surface provided with a light-emitting alert block 12. The light-emitting alert block 12 comprises a plurality of light-emitting components 121 arranged in a matrix. The light-emitting components 121 are light emitting diode (LED) units or any other types of light bulbs. The light-emitting alert block 12 is configured to form a central alert block 122 and two directional alert blocks 123. The central alert block 122 is between two said directional alert blocks 123. The central alert block 122 emits textual, pictorial, or glittering alert light. The directional alert blocks 123 emit direction-indicating alert light.

Referring to FIG. 1 again, the second light alarm 2, which is essentially the same as the first light alarm 1, comprises a substrate 21. And the substrate 21 has at least one surface provided with a light-emitting alert block 22. The light-emitting alert block 22 comprises a plurality of light-emitting components arranged in a matrix. The light-emitting components are light emitting diode (LED) units or any other types of light bulbs. The light-emitting alert block 22 is configured to form a central alert block 222 and two directional alert blocks 223. The central alert block 222 is between two directional alert blocks 223. The central alert block 222 emits textual, pictorial, or glittering alert light. The directional alert blocks 223 emit direction-indicating alert light.

Referring to FIG. 1 again, the control unit 3 is selectively installed in the first light alarm 1 or the second light alarm 2 and electrically connected to the light-emitting alert blocks 12, 22 of the first and second light alarms 1, 2, so as to control the central alert blocks 122, 222 for emitting textual, pictorial, uninterruptible, or glittering alert light and control the directional alert blocks 123, 223 for emitting direction-indicating alert light. Also, the control unit 3 is electrically connected to one or more power switches 31, 32. The power switches 31 comprise a vehicle failure alert switch, an emergency call alert switch, an uninterruptible alert switch, and a glittering alert switch. The power switches 32 are direction-indicating switches. The power switches 31, 32 are selectively installed in selected portions of the first and second light alarms 1, 2, and are configured to control the light-emitting alert blocks 12, 22 of the first and second light alarms 1, 2, respectively, which includes controlling the central alert blocks 122, 222 and the directional alert blocks 123, 223. In practice, a user presses the intended switch so the respective alert block emits light having one of the aforesaid effects.

Referring to FIG. 1 again, the power supply 4 is a dry battery, a rechargeable storage battery, or any other device capable of generating power, and is electrically connected to the control unit 3, the light-emitting alert block 12 of the first light alarm 1, and the light-emitting alert block 22 of the second light alarm 2, so power is supplied to the first and second light alarms 1, 2 for converting electrical energy into light energy.

Referring to FIG. 1 again, the connection components 5 are two flexible bands. Each of the bands has two ends coupled to selected portions or upper ends of the first light alarm 1 and the second light alarm 2, respectively. One of the connection components 5 is provided with a conduction component 51 electrically connected to the first light alarm 1 and the second light alarm 2. The conduction component 51 is a wire.

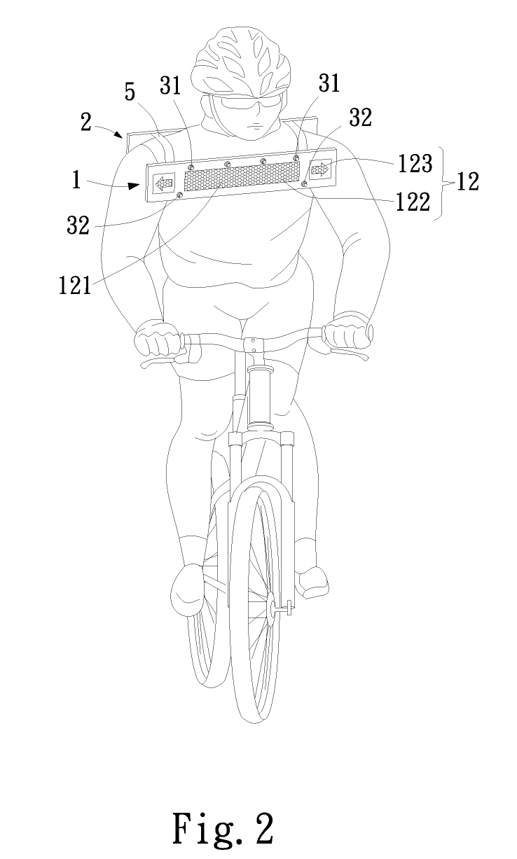

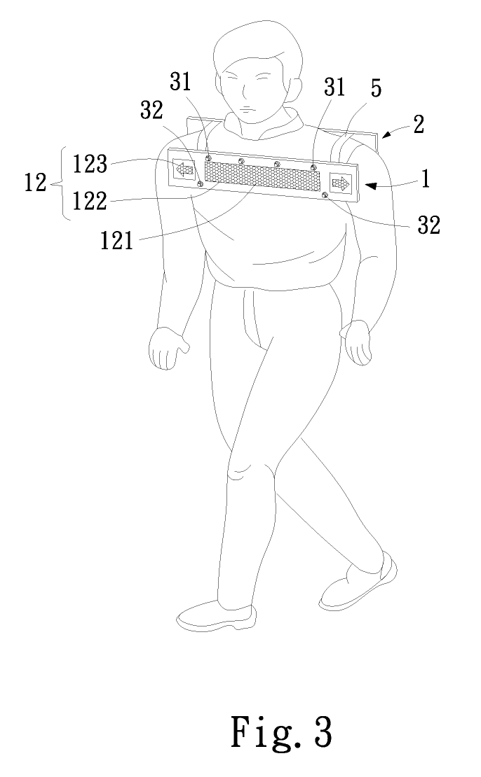

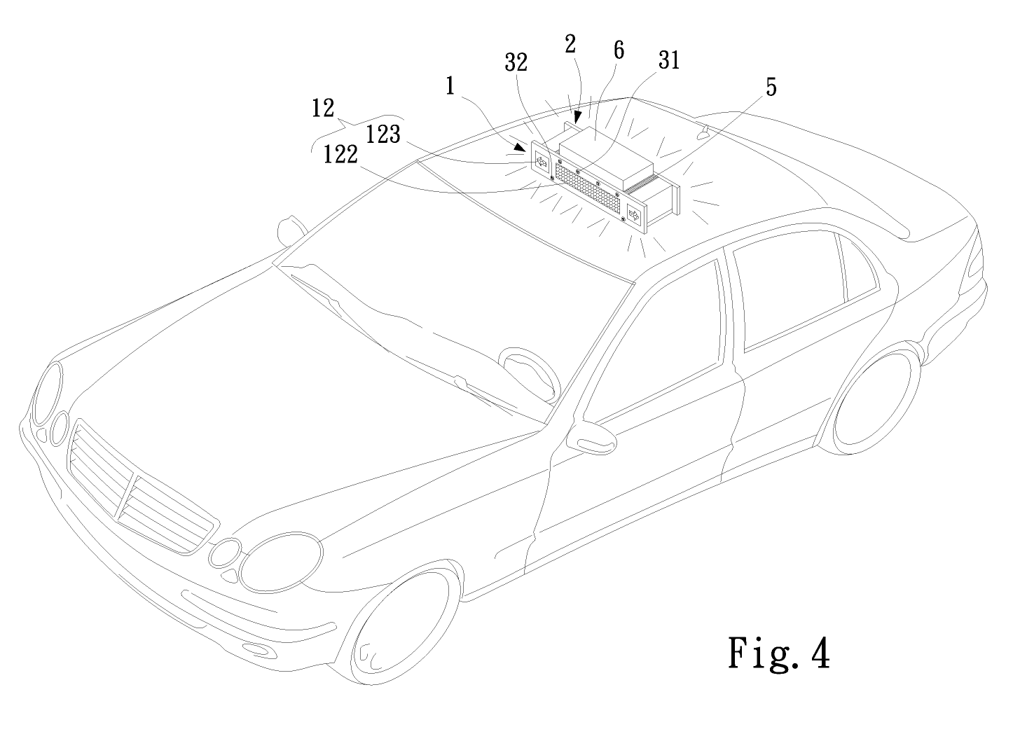

In the aforesaid embodiment, an active light-emitting alert device of the present invention is carried by a user or placed at a specific venue as needed so as to emit alert light from the first light alarm 1 and the second light alarm 2 of the active light-emitting alert device, as far as the embodiment and methodology are concerned. Referring to FIG. 2, the active light-emitting alert device is used by a bicycle rider, for example, with the connection components 5 straddling the bicycle rider's shoulder, so that the first light alarm 1 is hung in front of the bicycle rider's chest, and the second light alarm 2 rests on the bicycle rider's back. The bicycle rider presses the power switches 31 to control emission of light from the central alert blocks 122, 222; and, to make a sharp turn at a corner, the bicycle rider presses the power switches 32 to control emission of light from the directional alert blocks 123, 223, thereby alerting other drivers or riders to the imminent diversion. Furthermore, referring to FIG. 3, an active light-emitting alert device of the present invention is carried by a jogger, a traffic police officer, a traffic auxiliary police officer, a road maintenance worker, or a street cleaner; with the connection components 5 straddling the user's shoulder, so that the first light alarm 1 is hung in front of the user's chest, and the second light alarm 2 rests on the user's back. The user controls emission of conspicuous visible light, such as preset uninterruptible light or glitter, from the central alert blocks 122, 222 and the directional alert blocks 123, 223, thereby enhancing the safety of the user on duty or during exercise. Furthermore, referring to FIG. 4, an active light-emitting alert device of the present invention is placed on the roadside after a vehicle breakdown, for example, with the connection components 5 straddling a fixation base 6 that exhibits magnetism. The first light alarm 1 is hung in front of the fixation base 6, and the second light alarm 2 is hung on the back of the fixation base 6. The fixation base 6 is held on the top of a vehicle, on the trunk of a vehicle, or a distance behind a vehicle, and the driver controls emission of light from the central alert blocks 122, 222 and the directional alert blocks 123, 223, so as to display alert signs of an emergency call or a vehicle breakdown, thereby asking other drivers to evade imminent danger.

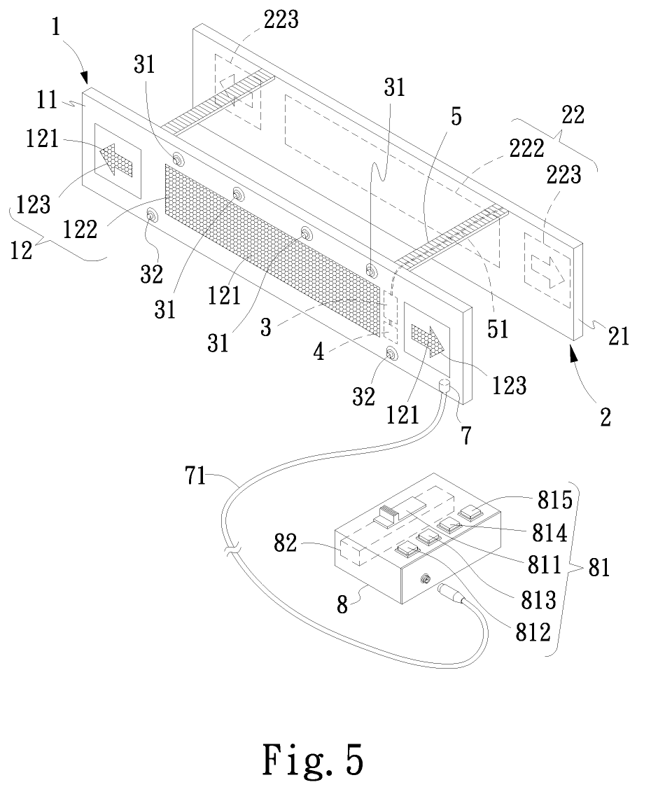

Referring to FIG. 5, in another preferred embodiment, to enable an active light-emitting alert device of the present invention to have an enhanced light-emitting effect, an electrical connector 7 is provided at a selected portion of the first light alarm 1 or the second light alarm 2. The inner end of the electrical connector 7 is electrically connected to the control unit 3, and a conduction component 71 is inserted and connected to the outer end of the electrical connector 7. The conduction component 71 is a wire. The other end of the conduction component 71 is electrically connected to an external controller 8. The external controller 8 has one or more power switches 81 for controlling the first light alarm 1 and the second light alarm 2, and is externally connected to a power supply 82. The power switches 81 comprise a direction-indicating switch 811, a vehicle failure alert switch 812, an emergency call alert switch 813, an alert switch 814, and a glittering alert switch 815. The external controller 8 can be installed on the handle of a bicycle (not shown) or connected to the inside of a vehicle (not shown) to enable a user to control emission of textual, pictorial, uninterruptible, glittering alert light, or alert light for making a rescue call or indicating a direction, from the first light alarm 1 and the second light alarm 2, thereby enhancing the safety of related activities or work.

Hence, the present invention meets the three requirements for patentability, namely novelty, an inventive step, and industrial applicability. Regarding novelty and an inventive step, the present invention provides an active light-emitting alert device comprising the first light alarm 1, the second light alarm 2, and the connection components 5, such that the first light alarm 1 and the second light alarm 2 is hung in front of a user's chest and rests on the user's back, respectively, allowing the light-emitting alert blocks of the first light alarm 1 and the second light alarm 2 to emit textual or glittering alert light or alert light for indicating a direction, and in consequence the user can travel or work safely. Regarding industrial applicability, any products derived from the present invention should be capable of meeting the current market needs to the full.

The aforesaid preferred embodiments are only illustrative of the features and functions of the present invention but are not intended to restrict the scope of the present invention. It is apparent to those skilled in the art that all equivalent modifications and changes made in the aforesaid preferred embodiments according to the spirit and principle in the disclosure of the present invention should fall within the scope of the present invention. Accordingly, the scope of the present invention should be defined with the appended claims.

What is claimed is:

1. An active light-emitting alert device, comprising:
a first light alarm with at least one surface provided with a light-emitting alert block, the light-emitting alert block comprising a plurality of light-emitting components arranged in a matrix;
a second light alarm with at least one surface provided with a light-emitting alert block, the light-emitting alert block comprising a plurality of light-emitting components arranged in a matrix;
a control unit electrically connected to the light-emitting alert block of the first light alarm and the light-emitting alert block of the second light alarm;
a power supply electrically connected to the control unit, the light-emitting alert block of the first light alarm, and the light-emitting alert block of the second light alarm; and
at least one connection component with two ends coupled to a selected portion of the first light alarm and the second light alarm, respectively.

2. The active light-emitting alert device of claim 1, wherein a plurality of light-emitting components of the light-emitting alert block of the first light alarm and the second light alarm are light-emitting diode (LED) units.

3. The active light-emitting alert device of claim 1, wherein the light-emitting alert blocks of the first and second light alarms each comprise a central alert block and two directional alert blocks, respectively, and the central alert block is between two said directional alert blocks, respectively.

4. The active light-emitting alert device of claim 1, wherein the control unit is electrically connected to one or more power switches configured to control the light-emitting alert blocks of the first and second light alarms, respectively.

5. The active light-emitting alert device of claim 1, wherein the number of the connection component is two, each having two ends coupled to upper ends of the first light alarm and the second light alarm, respectively, wherein one of the connection components is provided with a conduction component electrically connected to the first light alarm and second light alarm.

6. The active light-emitting alert device of claim 5, wherein the conduction component of the connection components is a wire.

7. The active light-emitting alert device of claim 1, wherein an electrical connector is provided at a selected portion of the first light alarm or the second light alarm, and has an inner end electrically connected to the control unit and an outer end connected to a conduction component electrically connected to an external controller.

8. The active light-emitting alert device of claim 7, wherein the external controller has one or more power switches for controlling the first light alarm and the second light alarm, and is externally connected to a power supply.

9. The active light-emitting alert device of claim 8, wherein the power switches of the external controller comprise a direction-indicating switch, a vehicle failure alert switch, an emergency call alert switch, an uninterruptible alert switch, and a glittering alert switch.
